(19) United States
(12) Patent Application Publication
(10) Pub. No.: US 2026/0032323 A1
(43) Pub. Date: Jan. 29, 2026

(54) INDIVIDUALIZED MEDIA CONTENT GENERATION AND DELIVERY

(71) Applicant: DISH Network Technologies India Private Limited, Bengaluru (IN)

(72) Inventors: Yatish Jayant Raikar, Bengaluru (IN); Karthik Hegde, Bengaluru (IN); Rakesh Ramesh, Bengaluru (IN); Srijan Sivakumar, Bengaluru (IN)

(21) Appl. No.: 18/899,002

(22) Filed: Sep. 27, 2024

(30) Foreign Application Priority Data
Jul. 23, 2024 (IN) 202441056151

(51) Int. Cl. H04N 21/81; G06F 40/35; H04N 21/439; H04N 21/45

(52) U.S. Cl. CPC H04N 21/8106; G06F 40/35; H04N 21/4394; H04N 21/4532

(57) ABSTRACT

Techniques for individualized media content generation and delivery are provided. In one example, a request to provide media content to a user via a user device is received and a profile of the user comprising user values for each of one or more attributes is identified. A portion of the media content is identified for modification based on a user value and a content value for the portion. The media content is modified using alternative content generated for the portion based on the user value and provided to the user via an application executing on the user device.

### CROSS REFERENCE TO RELATED APPLICATIONS

This application claims priority to Indian Provisional Patent Application Serial No. 202441056151 filed on July 23, 2024, in the Indian Intellectual Property Office, the disclosure of which is incorporated by reference in its entirety for all purposes.

### BACKGROUND OF THE INVENTION

Current media content delivery techniques, including internet-based streaming and traditional broadcast transmission, have revolutionized how audiences access video, audio, and other forms of media. These methods allow content to be distributed widely, reaching diverse audiences through a variety of devices and platforms. Despite these advancements, the ability to deliver truly individualized content to each user remains limited. While streaming services can offer some level of personalization through user profiles and recommendation algorithms, they often fall short in addressing specific preferences and characteristics of individual viewers. Broadcast transmission, which operates on a one-size-fits-all model, faces even greater challenges in this regard. As media consumption continues to evolve, there is a growing need for solutions that can cater to the unique characteristics and preferences of each user, enhancing the overall viewing experience and ensuring that content is accessible and engaging for everyone.

### BRIEF SUMMARY OF THE INVENTION

In some embodiments, a method of providing individualized content to a user is provided. The method may include receiving, by an application executing on a user device, a user request to provide audiovisual content to a user via the user device. The method may further include identifying, by the application, a linguistic profile of the user. The linguistic profile may comprise user values for each of one or more predefined language attributes. The user values may comprise a user language proficiency value indicating the user’s proficiency level in a language, a user dialect value indicating a preferred dialect of the language, or both. The method may further include receiving, by the application, the audiovisual content from a content provider server system via one or more communications networks. The audiovisual content may comprise audio of a plurality of words or phrases spoken in the language. The method may further include identifying, by the application, one or more content values for a first word or phrase in a portion of the audio. Each of the one or more content values may corresponds to a predefined language attribute of the one or more predefined language attributes, and the one or more content values may comprise a content language proficiency value indicating a minimum proficiency level needed to understand the first word or phrase, a content dialect value indicating that the first word or phrase is specific to a first dialect, or both. The method may further include determining, by the application, that the minimum proficiency level indicated by the content language proficiency value is greater than the user’s proficiency level indicated by the user language proficiency value, the first dialect indicated by the content dialect value is not the same as the preferred dialect indicated by the user dialect value, or both. The method may further include identifying, by the application, an alternative word or phrase for the first word or phrase based on a meaning of the first word or phrase, as well as the user language proficiency value, the user dialect value, or both. The method may further include generating, by the application, replacement audio including the alternative word or phrase. The method may further include replacing, by the application, the portion of the audio with the replacement audio in the audiovisual content to produce modified audiovisual content. The method may further include presenting, by the application, the modified audiovisual content to the user via the user device in response to the user request.

In some embodiments, another method of providing individualized content to a user is provided. The method may include receiving, by an application executing on a user device, a user request to provide media content to a user via the user device. The method may further include identifying a profile of the user. The profile may comprise user values for each of one or more predefined attributes. The method may further include receiving the media content from a content provider server system via one or more communications networks. The media content may comprise a plurality of portions and each portion of the plurality of portions may be associated with a first content value for a predefined attribute of the one or more predefined attributes. The method may further include identifying a portion of the media content for modification based on a user value for the predefined attribute and the first content value of the portion. The method may further include generating alternative content for the portion based on the user value. The method may further include generating modified media content using the alternative content. Generating the modified media content may include replacing the portion of the media content with the alternative content or adding the alternative content to the portion of the media content. The method may further include providing the modified media content to the user via the application executing on the user device.

In some embodiments, identifying the portion of the media content for modification comprises determining that the first content value and the user value are different. In some embodiments, the methods may further include executing an artificial intelligence (AI) model on the portion of the media content, and receiving, from the AI model, the first content value for the predefined attribute. In some embodiments, the AI model is trained to generate content values for portions of media content.

In some embodiments, the media content comprises vocal audio content, and the method further comprises obtaining a transcription of the vocal audio content; identifying a word or phrase of interest in the transcription of the vocal audio content; and identifying a sample of the vocal audio content that contains the word or phrase of interest as the portion of the media content. In some embodiments, the media content further comprises closed captions, subtitles, or both, and the transcription of the vocal audio content is obtained from the closed captions, the subtitles, or both. In some embodiments, obtaining the transcription comprises inputting the vocal audio content to a speech-to-text conversion machine learning model. In some embodiments, generating the alternative content comprises identifying a replacement word or phrase for the word or phrase of interest based on a definition of the word or phrase of interest and the user value; and generating a new audio sample containing the replacement word or phrase. In some embodiments, the modified media content is generated by replacing the sample of the vocal audio content with the new audio sample. In some embodiments, generating the new audio sample containing the replacement word or phrase comprises inputting the replacement word or phrase and information about a voice that vocalized the word or phrase in the vocal audio content to a generative text-to-speech AI model and receiving the new audio sample from the generative text to speech AI model.

In some embodiments, the media content comprises text; generating the alternative content comprises identifying a replacement word for a word of interest included in the text based on a definition of the word of interest and the user value; and generating the modified media content comprises replacing the word of interest in the text with the replacement word. In some embodiments, the media content comprises visual content; an image in the visual content is identified as the portion; generating the alternative content comprises modifying the image based on the user value; and generating the modified media content comprises replacing the image in the visual content with the modified image. In some embodiments, the predefined attribute is an age attribute; the content value for the portion indicates an appropriate age for consumption of the portion; the user value indicates an age of the user; identifying the portion for modification comprises determining that the appropriate age for consumption exceeds the age of the user; and generating the alternative content comprises identifying replacement content for the portion that is appropriate for users having the age of the user.

In some embodiments, the predefined attribute is a language proficiency attribute for a language; the user value indicates a proficiency with which the user comprehends words or phrases in the language; the content value indicates a minimum proficiency needed to comprehend a word or phrase in the language contained in the portion; identifying the portion for modification comprises determining that the user value is less than the content value for the portion, indicating that a higher language proficiency is needed to comprehend the word or phrase contained in the portion of the media content; and generating the alternative content comprises identifying a replacement word or phrase that is comprehensible to users having a language proficiency indicated by the user value.

In some embodiments, the predefined attribute is a regional language attribute for a language; the user value indicates a first dialect of the language that is understood by the user; the content value indicates whether a word or phrase contained in the portion is common to all dialects of the language or is derived from a particular dialect of the language; identifying the portion for modification comprises determining, based on the content value and the user value, that the word or phrase contained in the portion is specific to a second dialect of the language that is different from the first dialect, indicating that a different word or phrase is used for the word or phrase in the portion of the media content by users having the user value; and generating the alternative content comprises identifying the different word or phrase for the user value.

In some embodiments, the methods further include creating, by the application executing on the user device, an audio recording of speech attributable to the user; providing, by the application executing on the user device, the audio recording to a spoken language analysis machine learning model to identify the user values for at least one of an age attribute that indicates appropriate content ratings for the user, a language attribute that indicates a language spoken by the user, a dialect attribute that indicates a dialect of the language spoken by the user, or a language proficiency attribute that indicates how well the user comprehends the language; receiving, from the spoken language analysis machine learning model, the user values for the one or more language attributes; and updating the profile of the user to include the user values for the one or more language attributes.

In some embodiments, the methods further include receiving a history of media content consumption by the user, wherein the history of media content consumption identifies past media content consumed by the user; analyzing the history of media content consumption to identify at least one of an average content rating for the past media content, a language of speech represented in the past media content, a dialect of the language represented in the past media content, or a minimum language proficiency needed to comprehend the speech in the past media content; and updating the user values in the profile of the user for at least one of an age attribute based on the average content rating, a language attribute based on the language of the speech, a dialect attribute based on the dialect of the language, or a language proficiency attribute based on the minimum language proficiency.

In some embodiments, the history of media content consumption further identifies the past media content that was consumed by the user with closed captioning enabled; and analyzing the history of media content consumption to identify the user values comprises adjusting a language proficiency value for the language proficiency attribute associated with the language, the dialect, or both, of speech in the past media content that was consumed by the user with closed captioning enabled.

In some embodiments, an individualized media content delivery system is provided including one or more processors and a computer-readable storage media storing computer-executable instructions. The computer executable instructions, when executed by the one or more processors, may cause the individualized media content delivery system to receive a user request to provide media content to a user via a user device. The computer executable instructions may further cause the individualized media content delivery system to identify a profile for the user, wherein the profile comprises user values for each of one or more predefined attributes. The computer executable instructions may further cause the individualized media content delivery system to receive the media content, wherein the media content comprises a plurality of portions and each portion of the plurality of portions has a first content value for a predefined attribute of the one or more predefined attributes. The computer executable instructions may further cause the individualized media content delivery system to identify a portion of the media content for modification based on a user value for the predefined attribute and the first content value of the portion. The computer executable instructions may further cause the individualized media content delivery system to generate alternative content for the portion based on the user value. The computer executable instructions may further cause the individualized media content delivery system to generate modified media content using the alternative content, wherein generating the modified media content includes replacing the portion of the media content with the alternative content or adding the alternative content to the portion of the media content. The computer executable instructions may further cause the individualized media content delivery system to provide the modified media content to the user via the application executing on the user device.

### BRIEF DESCRIPTION OF THE DRAWINGS

FIG. 1 illustrates an embodiment of an individualized media content delivery system.

FIG. 2 illustrates an exemplary system architecture of an individualized media content delivery system according to embodiments described herein.

FIG. 3 illustrates an exemplary data flow for individualizing media content according to embodiments described herein.

FIG. 4 illustrates an exemplary data flow for classifying media content according to embodiments described herein.

FIG. 5 illustrates an exemplary data flow for modifying media content based on user values according to embodiments described herein.

FIG. 6 illustrates an exemplary data flow for generating a profile of a user according to embodiments described herein.

FIG. 7 illustrates an exemplary user interface for modifying a profile of a user according to embodiments described herein.

FIG. 8 illustrates an embodiment of a method for individualizing media content according to embodiments described herein.

FIG. 9 illustrates an embodiment of a method for generating a profile of a user according to embodiments described herein.

### DETAILED DESCRIPTION OF THE INVENTION

Various embodiments according to the present disclosure may provide for individualized media content generation and delivery. Video, audio, and other media content can be delivered by an ever increasing number of providers, on virtually any device with a screen or speaker, via any one or a combination of terrestrial and extraterrestrial communications networks, to almost anywhere in the world. As a result, content produced in, or for, one region can be consumed in another. To facilitate consumption by a potentially limitless range of audiences, each with their own unique characteristics, original media content, such as movies and television shows, be supplemented with additional content including subtitles, closed-captioning, and dubbed audio tracks.

While these solutions may facilitate consumption across people who speak different languages, they do not account for differences in language proficiency, regional dialects, and appropriate content ratings across individual media consumers. Subtitles, closed-captioning, and dubbed audio tracks often assume a uniform level of language understanding, which can lead to misinterpretations or reduced engagement for those with varying proficiency levels. Additionally, regional dialects and cultural nuances may not be accurately represented, potentially alienating viewers who are accustomed to specific vernaculars. Furthermore, content ratings and appropriateness can vary greatly between regions and individual consumers, necessitating a more personalized approach to media content delivery that considers these diverse factors to enhance user experience and satisfaction.

However, individualizing media content to particular users, or groups of users, presents several challenges. For example, in internet-based streaming, although there is the potential for personalized content delivery, it requires sophisticated algorithms and significant computational resources to analyze user preferences, language proficiency, and viewing habits in real-time. Additionally, maintaining privacy and data security while collecting and processing user information is a critical concern. In broadcast transmission, the challenge is even greater, as content is typically delivered to a broad audience without the capability for individualized adjustments. This one-size-fits-all approach struggles to accommodate the diverse linguistic, cultural, and content-rating preferences of individual viewers, leading to a less tailored and potentially less engaging experience. Addressing these challenges requires advancements in both technology and infrastructure to enable truly personalized media experiences across both streaming and broadcast platforms.

Embodiments described herein address these and other challenges by enabling content delivery devices, such as set-top-boxes, over-the-top (OTT) devices, and personal computing devices, to identify individual portions of original media content that may not meet the needs or preferences of a user, identify and/or generate alternative content for the identified portions, and modify the original content with the alternative content before providing it to the user. By distributing the various processes involved in individualizing content across a content provider and the potentially numerous content receivers, both internet-based streaming and broadcast content deliver can support individualized content for individual users or groups of users.

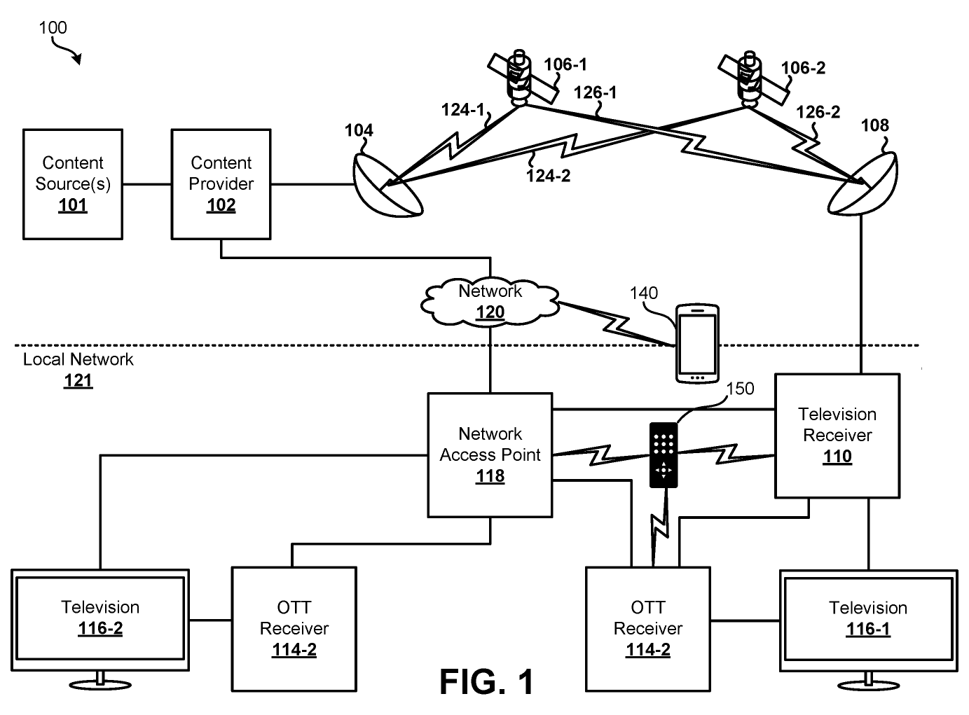

Further detail regarding individualized media content generation and delivery is provided in relation to the figures. FIG. 1 illustrates an embodiment of an individualized media content delivery system. For brevity, system 100 is depicted in a simplified and conceptual form and may generally include more or fewer systems, devices, networks, and/or other components as desired. Further, the number and type of features or elements incorporated within system 100 may or may not be implementation-specific, and at least some of the aspects of system 100 may be similar to a cable television distribution system, an IPTV (Internet Protocol Television) content distribution system, and/or any other type of media or content distribution system.

System 100 may include at least one network 120 that may facilitate bi-directional communication for data transfer between devices connected to network access point 118 and content provider 102. Additionally, or alternatively, network 120 may facilitate bi-directional communication for data transfer between content source(s) 101 and content provider 102. Network 120 is intended to represent any number of terrestrial and/or non-terrestrial network features or elements. For example, network 120 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular network, or any other type of communication network within which data may be transferred between and among respective components of the system 100.

System 100 may also include at least one local network 121 that establishes a bi-directional communication path for data transfer between and among television receiver 110, network access point 118, OTT receivers 114, televisions 116, mobile device 140, and/or one or more personal or business computing devices, such as local media servers, personal computers, or the like. Local network 121 may correspond to a home or business computing environment. Television receiver 110, together with OTT receivers 114 and televisions 116, may each be incorporated within or form at least a portion of a particular home or business computing network.

Television receiver 110 and OTT receivers 114 may correspond to television receivers and/or television converters, such as a set-top box (STB) for example, or smart TV content receivers. In another example, television receiver 110 and OTT receivers 114 may exhibit functionality integrated as part of or into a television; a DVR (Digital Video Recorder); a computer, such as a tablet computing device; or any other computing system or device, as well as variations thereof. Further, television receiver 110 may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection). For example, as disclosed further herein, one or more of the various elements or components of the at least one local network 121 may communicate using TCP/IP using one or more wireless techniques, such as Wi-Fi; or wired techniques, such as Ethernet or MoCA® (Multimedia over Coax Alliance). Still other embodiments are possible.

In practice, satellites 106 may each receive uplink signals 124 from satellite uplink 104. In this example, each of uplink signals 124 may contain one or more transponder streams of particular data or content, such as one or more particular television channels, as supplied by content provider 102. For example, each of the respective uplink signals 124 may contain various media content from content source(s) 101, such as encoded HD (High Definition) television channels, SD (Standard Definition) television channels, regional broadcast channels, on-demand programming, programming information, and/or any other content in the form of at least one transponder stream, in accordance with an allotted carrier frequency and bandwidth. In this example, different media content may be carried using different versions of satellites 106.

Satellites 106 may further relay uplink signals 124 to satellite dish 108 as downlink signals 126. Similar to uplink signals 124, each of downlink signals 126 may contain one or more transponder streams of particular data or content, such as various encoded and/or at least partially electronically scrambled television channels and/or on-demand programming, in accordance with an allotted carrier frequency and bandwidth. Downlink signals 126, however, may not necessarily contain the same or similar content as a corresponding one of uplink signals 124. For example, uplink signal 124-1 may include a first transponder stream containing at least a first group or grouping of television channels, and downlink signal 126-1 may include a second transponder stream containing at least a second, different group or grouping of television channels. In other examples, the first and second group of television channels may have one or more television channels in common. In sum, there may be varying degrees of correlation between uplink signals 124 and downlink signals 126, both in terms of content and underlying characteristics. Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, and/or ESPN®.

Satellite dish 108 may be provided to receive television channels (e.g., on a subscription basis) provided by content source(s) 101 and/or content provider 102, satellite uplink 104, and/or satellites 106. For example, satellite dish 108 may be receive particular transponder streams, or downlink signals 126, from one or more of satellites 106. As another example, satellite dish 108 may provide a plurality of television channel frequencies to a television frequency tuner of television receiver 110. Additionally, television receiver 110, which is communicatively coupled to satellite dish 108, may subsequently select via a tuner, decode, and relay particular transponder streams to television 116-1 for display thereon. For example, satellite dish 108 and television receiver 110 may, respectively, receive, decode, and relay at least one television channel to television 116-1. As another example, television receiver 110 may tune a television frequency tuner to a television channel frequency of a plurality of television channel frequencies received by satellite dish 108. Programming or content associated with the channel may generally be presented live, or from a recording as previously stored on, by, or at television receiver 110. Here, the channel may be output to television 116-1 in accordance with the HDMI/HDCP content protection technologies. However, other embodiments are possible. For example, the channel may be output to television 116-1 in accordance with the MoCA® (Multimedia over Coax Alliance) home entertainment networking standard. As another example, the channel may be output to television 116-1 in accordance with the Transmission Control Protocol (TCP) and/or Internet Protocol (IP) via network access point 118 over local network 121. In yet another example, the channel may be output to television 116-1 via a wired network connection over a private network containing television 116-1 and television receiver 110.

Further, television receiver 110 may select via a tuner, decode, and relay particular transponder streams to one or both of OTT receivers 114 which may in turn relay particular transponder streams to a corresponding television of televisions 116 for display thereon. For example, satellite dish 108 and television receiver 110 may, respectively, receive, decode, and relay at least one television channel to television 116-1 by way of OTT receiver 114-1. Additionally, or alternatively, television receiver 110 may select via a tuner, decode, and relay particular transponder streams directly to televisions 116, personal computer 150, and/or mobile device 140 for display thereon. Similar to the above-example, television channels may be presented live, or from a recording as previously stored on television receiver 110, and may be output to television 116-1 by way of OTT television receiver 114-1 in accordance with a particular content protection technology and/or networking standard.

Relaying transponder streams and/or digital content from television receiver 110 to televisions 116 via OTT receivers 114 may include transmission via wireless communication. For example, the at least one local network 121 may include a private content network. Television receiver 110 may then transmit digital content to OTT receivers 114 via the private content network. Additionally, or alternatively, relaying transponder streams and/or digital content from television receiver 110 to televisions 116 via OTT receivers 114 may include transmission via one or more wired connections. For example, television receiver 110 may be connected to OTT receivers 114 and/or televisions 116 via a networking cable, such as CAT-5, a coaxial cable, a universal serial bus (USB) cable, and the like.

In some embodiments, OTT receivers 114, televisions 116, personal computer 150, and/or mobile device 140 execute a client software application that includes a user interface for integrating live television content from television receiver 110 with the media content provided by content source(s) 101 and/or content provider 102. In some embodiments, the client functionality is provided by a Web site and is accessible by OTT receivers 114, televisions 116, personal computer 150, and/or mobile device 140 via a Web browser. When any of the devices wish to connect to a stream of television receiver 110 using the client application or via a Web browser interface, it may specify an IP address associated with television receiver 110 to access and pull the media stream from television receiver 110. This action sends a request to television receiver 110, and the request travels across local network 121 and/or network 120 (e.g., the public Internet) to television receiver 110.

OTT receivers 114, televisions 116, mobile device 140, and/or personal computer 150 may receive digital content from content source(s) 101 and/or content provider 102 via network 120. For example, while television receiver 110 may receive satellite television channels via satellite dish 108 and provide them to OTT receivers 114, OTT receivers 114 may also access network 120 via network access point 118, as described below, to stream digital content from content provider 102 and/or one or more OTT provider(s) directly, or via content provider 102, such as Netflix®, Spotify®, Google®, YouTube®, Disney®, Hulu®, Peacock®, etc. and relay the digital content to televisions 116 for display thereon. While described as streaming content, OTT receivers 114 may also transmit, receive, or otherwise have access to, other forms of data such as documents, databases, websites, email, search engine results, digital assistant interfaces, and the like.

For example, OTT receivers 114, televisions 116, mobile device 140, and/or television receiver 110 may collect various usage and/or user data. As described herein, usage data may include information identifying content provided to a user, such as individual media content titles, preferred genres, or the like. Additionally, or alternatively, usage data may include information related to interactions and/or input from a user via one or more user interfaces, such as a graphical user interface (GUI), a voice user interface (VUI), or the like. For example, usage data may include commands received via one or more user interfaces to control an operation of a device, such as when requesting particular media content. Additionally, or alternatively, usage data may include the raw and/or processed inputs used to generate such commands, such as raw and/or processed audio data from a voice enabled remote control, such as remote control 150, search query terms and/or phrases typed into a graphical user interface, or the like. Usage and/or user data may further include identifying characteristics and/or demographic information about a user, such as the user’s age, preferred languages, language proficiencies, preferred regional language, or the like.

As described further herein, usage and/or user data may be used to provide individualized content to users. Providing individualized content may include modifying original content with alternative content based on the usage and/or user data so that the individualized content meets the needs or preferences of the user. Individualized content that meets the needs or preferences of a user may include content that: is in a language spoken or understood by the user; uses the vernacular and/or vocabulary of the regional dialect, if any, of the language, or languages, spoken or understood by the user and/or can be understood by a person with the same or similar proficiency in the language, or languages, as the user; and has an appropriate content rating for an age of the user.

Users can control what usage and/or user data is provided to, derived, or otherwise obtained by devices, as well as how the data can be used. For example, user’s may have access to one or more user interfaces accessible via mobile device 140, television receiver 110, OTT receivers 114, and/or televisions 116 to control their user profile privacy settings. As described further herein, such user interfaces may provide users with the option to provide user data, such as age, language, and preferred content settings. Additionally, or alternatively, such user interfaces may allow users to define what tertiary data, such as usage data, can be used to derive user data and/or the user data that can be derived. In some embodiments, usage and/or user data is maintained by local devices, such as television receiver 110, without transmitting such data outside of local network 121. As described further herein, maintaining usage and/or user data locally may reduce the risk of unauthorized access. Locally maintained usage and/or user data may further enable more efficient and/or accurate media content individualization. In some embodiments, usage and/or user data may be securely transmitted to content provider 102 for storage in association with a user account maintained by content provider 102. Subsequently, such usage and/or user data may be accessed by one or more processes and/or services provided by content provider 102 may individualize media content based on the usage and/or user data before transmission to a requesting device.

OTT receivers 114, televisions 116, mobile device 140, and/or personal computer 150 may access content from content provider 102 via one or more web-based applications. In some embodiments, such web-based applications may include user interfaces that enable a user to access and view live programming provided by regional broadcast television channels via television receiver 110 from within the web-based application. Additionally, or alternatively, OTT receivers 114 may provide one or more user interfaces that enable a user to integrate television receiver 110 as a television content input for OTT receivers 114, which may then be added via a user interface of a web-based application. For example, such user interfaces may enable a user to provide identifying information for television receiver 110, such as make and model information, network address information, user account information, and the like. In response, the web-based applications, and/or OTT receivers 114 may initiate a connection with television receiver 110 via local network 121. Subsequently, when television receiver 110 provides media content to OTT receivers 114 via local network 121, the media content may be displayed within the web-based applications of OTT provider(s) 101.

Network access point 118 may function similar to a wireless router. For example, network access point 118 may receive digital communication from television receiver 110 and route the digital communication to an intended recipient of OTT receivers 114, televisions 116, personal computer 150, and mobile device 140. Network access point 118 may receive the digital communication via a wired connection from television receiver 110, such as via an Ethernet or MoCA® connection. Network access point 118 may then transmit the digital communication to the appropriate recipient via a wireless communication standard, such as Wi-Fi, Bluetooth®, ZigBee®, or the like. Additionally, network access point 118 may receive wireless communication from any of OTT receivers 114, televisions 116, personal computer 150, and mobile device 140 and relay the communication to television receiver 110 via a wired or wireless connection. For example, OTT receiver 114-2 may transmit a request to television receiver 110 via network access point 118 for live television media content corresponding to one of the transponder streams.

As described further below, the at least one local network 121 may include one or more general networks or general purpose networks. General networks may function in a similar manner, or for a similar purpose, as home or business local area networks configured to provide network access to a wide array of electronic devices for general purpose computing, such as email, web-browsing, and the like. Network access point 118 may establish, or otherwise provide access to, the general network. For example, network access point 118 may be a wired or wireless router or switch device configured to receive and distribute data from and to various devices coupled with it and/or between other networks, such as network 120. After connecting to network access point 118, the various electronic devices may transmit and/or receive data via the general network. In some embodiments, a general network is defined as a network which a user explicitly authorizes devices to use for communication by providing a password and SSID, or other access credentials. In contrast, access to private networks, such as those described below, may be managed by a device such as television receiver 110, and users may be otherwise unable to directly provide access credentials to such a network.

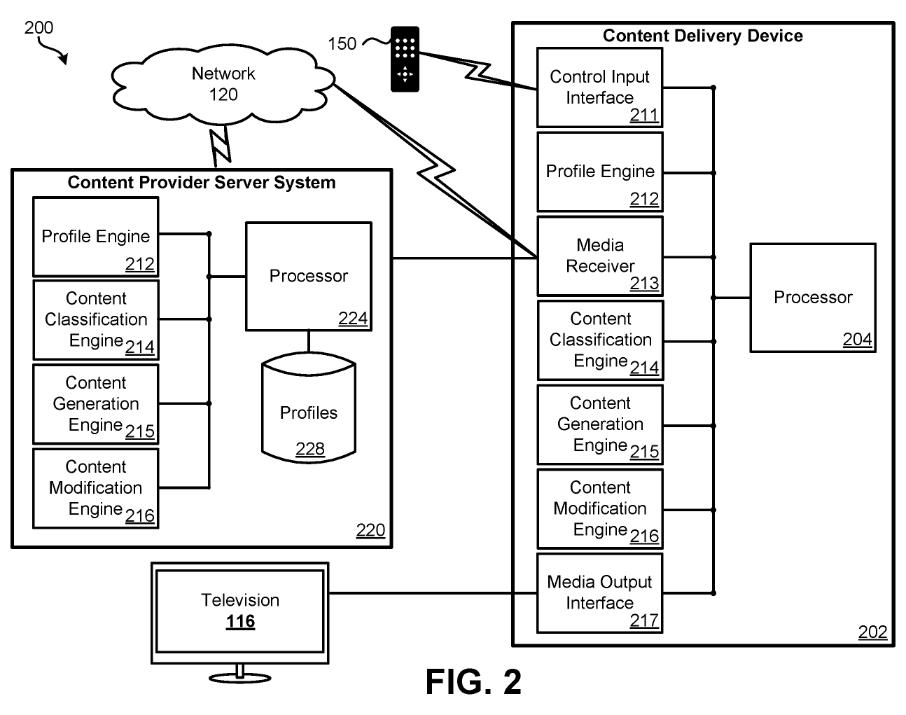

FIG. 2 illustrates an exemplary system architecture of an individualized media content delivery system 200. System 200 may include one or more distributed devices and/or systems configured to provide individualized media content for consumption by users. As described herein, media content may include audio media content, such as music, audiobooks, podcasts or the like. Media content may further include visual content, such as images, documents, text, social media, or the like. Further still, media content may include audio-visual content, such as movies, television shows, publicly shared video content, or the like. As further described above, individualizing such media content may include making one or more modifications to an original version of the media content to better suit the needs and/or interests of one or more users. For example, original audio content, such as a song or dialogue in a movie, may be modified to replace words or phrases that may be inappropriate, confusing, or unclear to a user, with words or phrases that are appropriate for, and will be understood by, the user. As another example, original visual content, such as a picture or imagery in a television show, can be modified to depict alternative content that is better suited to a particular individual.

System 200 includes content provider server system 220 and content delivery device 202. System 200 also includes network 120 that may facilitate bi-directional communication between content provider server system 220 and content delivery device 202. In some embodiments, network 120 includes a satellite-based telecommunications network. Additionally, or alternatively, network 120 may include one or more general networks or general purpose networks, such as the Internet.

As described above, content delivery device 202 may be configured to request and receive media content from one or more sources, such as content provider server system 220 and/or one or more OTT services, determine a profile of one or more users who may consume the media content, individualize the media content for consumption by the one or more users, and output the individualized media content for consumption via one or more outputs, such as a display and/or speaker. Content delivery device 202 may include one or more software and/or hardware components, such as control input interface 211, profile engine 212, media receiver 213, content classification engine 214, content generation engine 215, content modification engine 216, media output interface 217, and processor 204. As described above, content delivery device 202 may by a television or OTT receiver, such as television receiver 110 and OTT receivers 114 described above. Additionally, or alternatively, content delivery device 202 may be a personal computing device with one or more output interfaces, such as mobile device 140 as described above, a laptop, a tablet, a smart display, a smart speaker, or the like.

Control input interface 211 may include one or more hardware components configured to receive one or more types of control inputs from a user. For example, control input interface 211 may include a touchscreen and/or one or more physical interfaces a peripheral device, such as a mouse, keyboard, joystick, or the like. As another example, control input interface 211 may include one or more wireless and/or wired communications interfaces, such as a Wi-Fi, Bluetooth®, UWB, infrared (IR), or other hardware receiver that enables content delivery device 202 to receive control inputs from one or more devices, such as a mobile device, remote 150, or the like.

Control input interface 211 may include one or more hardware and/or software components configured to process control inputs from a user. For example, control input interface 211 may include an analog-to-digital converter (ADC) and/or a digital-to-analog converter (DAC) for processing voice commands captured by a microphone (e.g., integrated within remote control 150 and/or content delivery device 202). Control input interface 211 may interpret such voice inputs to identify actionable commands. For example, control input interface 211 may identify a function to be performed by one or more components of content delivery device 202 from the voice input and cause the one or more components to perform the function. Actionable voice commands for content delivery device 202 may include requests to view, or otherwise consume, particular media content, such as a specific television channel or a specific media title. Actionable voice commands may further include requests to control an operation of content delivery device 202 and/or television 116, such as display settings, volume, playback controls, DVR controls, or the like.

In some embodiments, control input interface 211 analyzes control inputs from users to determine one or more characteristics for a user. Additionally, or alternatively, control input interface 211 may provide the raw and/or processed control inputs to profile engine 212 for analysis. For example, control input interface 211 may provide a processed control input to profile engine 212 that indicates which media content was requested by the user. As another example, control input interface 211 may provide raw and/or processed audio data corresponding to a voice input from the user to profile engine 212 for additional language and speech processing.

Profile engine 212 may include one or more software components configured to determine and manage one or more profiles of users associated with content delivery device 202. As described herein, a profile of a user, or group of users, can include values for predefined attributes exhibited or embodied by users as a whole. Such predefined attributes may include an age attribute, a preferred content rating attribute, a maximum allowed content rating attribute, preferred content attributes, preferred genre attributes, spoken and/or understood language attributes, a preferred language attribute, regional language preference attributes, or the like. Each attribute of a profile may be populated with values for a particular user, or for a group of users. For example, a profile of an individual user may include specific values determined for, and/or provided by, the individual user. As another example, a profile of a group of users may include common values for each user of the group, such as the age of the youngest member, a lowest preferred content rating, the language(s) spoken and/or understood by every user, the lowest language proficiency within the group of users, or the like.

Profile engine 212 may maintain separate user profiles for each user associated with content delivery device 202. Additionally, or alternatively, profile engine 212 may maintain a single group profile for all or a subset of the users associated with content delivery device 202. For example, given a group of users that includes two adults and two children, a profile may be defined for each person, as well as for each unique combinations of users, such as an adult group, a children’s group, and a family group. In some embodiments, profile engine 212 maintains separate user profiles for each user associated with a user account through which media content is requested. In this way, media content can be individualized based on the user, or users, who will be consuming the media content.

Profile engine 212 may generate profiles for users and/or groups of users based on explicit information provided by a user. For example, profile engine 212 may populate profiles with settings and/or preferences provided by a user via one or more user interfaces, as described further below. Additionally, or alternatively, profile engine 212 may automatically determine the values for one or more attributes of a profile based on implicit information obtained from or about a user. For example, one or more preferences may be determined from historical media consumption by a user or group of users, such as the genres commonly consumed, content ratings of consumed media content, the language of the media content, use of subtitles, minimum and/or average language proficiency required to understand consumed content, or the like. Additionally, or alternatively, one or more preferences may be determined from control inputs, such as search strings, voice commands, or the like. For example, by analyzing voice command recordings from a user, a language proficiency, approximate age, or the like may be determined for the user.

Media receiver 213 may include one or more software and/or hardware components configured to receive media content for consumption by a user. For example, in response to receiving a control input requesting a particular media content title, media receiver 213 may transmit a request via network 120 to content provider server system 220 for the requested media content. In response, media receiver 213 may receive the requested media content from content provider server system 220 via network 120. Additionally, or alternatively, media receiver 213 may include one or more hardware and/or firmware components, such as a tuner and a decoder, configured to receive RF signals from an antenna (e.g., satellite or over-the-air), or cable, interface, and convert them into a digital stream representing media content for a particular television channel, media title, radio station, or the like. In response to receiving a control input requesting a particular content channel, stream, or station, media receiver 213 may cause the tuner to tune to the requested channel and begin decoding the incoming media content.

In some embodiments, media receiver 213 provides the media content directly to media output interface 217 for output to a user, such as via television 116. For example, media content that is individualized for a user by content provider server system 220, as described below, or for which one or more settings and/or preferences indicate that individualization is not to be performed, may be provided directly to media output interface 217. For media content that is to be individualized, media receiver 213 may provide such content to content classification 214, content generation engine 215, and/or content modification engine 216.

Content classification engine 214 may include one or more software components configured to produce classifications for individual portions of media content, from which determinations as to which portions are to be individualized may be made. As described herein, portions of media content may include distinct and identifiable parts of a larger piece of media that carry meaning or significance on their own. Put differently, a portion may be a component piece that is recognizable to a human observer as having its own meaning or definition, regardless of whether the meaning or definition is known to that observer. For example, a portion of an image may include a physical object or text depicted in the image. As another example, a portion of audio content (e.g., a song, an audiobook, a podcast, or an audio track accompanying a movie or show) may include audio signals representing an utterance of a word or phrase. In yet a further example, a portion of a text, such as a text document, subtitle track, closed captioning text, or the like, may include a written word or phrase.

Content classification engine 214 may use one or more techniques to identify distinct portions of media content. For example, content classification engine 214 may use various computer vision techniques including object detection, image segmentation, and feature extraction to identify discrete portions of visual content, to enable the recognition of distinct elements like faces, objects, and scenes within images and videos. As another example, content classification engine 214 may use speech recognition, natural language processing, and audio signal processing to identify discrete words or phrases from audio content. Once discrete words or phrases have been identified in the audio content, the representative audio content can be transcribed into textual representations of the words or phrases. Portions of audio content for which synchronized transcriptions are readily available, such as movies with published subtitles and/or video with closed captioning, can be identified from the text of the transcription corresponding to the point in the audio content when the text would be displayed.

Once identified, content classification engine 214 may use one or more machine learning models to generate one or more classifications for some or all of the portions of media content. Each classification may correspond to a profile attribute. In other words, each portion that is classified by content classification engine 214 may receive unique classifications for all or a subset of the profile attributes. In some embodiments, a single machine learning classifier is used to generate each of the classifications for a portion of media content. Additionally, or alternatively, multiple classifiers, each corresponding to one or more profile attributes, may be executed on a portion to generate each of the classifications. For example, a content rating classifier may be used to determine a content rating for each classified portion. As another example, one or more language classifiers may be used to determine the language of a word or phrase depicted or represented in a portion, whether the word or phrase is specific to a regional variation of the language, and/or a language proficiency level typically needed to comprehend the word or phrase.

Content generation engine 215 may include one or more software components that generate alternative content for a portion of media content. As described herein, alternative content may include content of the same form as the original media content. Compared to the original substance of the original media content (e.g., visual objects, spoken words or phrases, or the like), alternative content may depict or represent the original substance in a different way, with or without changing the underlying meaning or definition attributable to the original substance. For example, in the case of visual content, a portion of the original imagery in the visual content may depict a word or phrase for which a depiction of a word or phrase having a similar meaning may be generated as the alternative content. As another example, original imagery may depict an explicit or violent gesture, object, or act, for which a depiction of an innocuous or harmless gesture, object, or act may be generated as the alternative content. Additionally, or alternatively, alternative content for depictions of explicit and/or violent content may include an obfuscation of the original content such as via pixelation.

In the case of audio content, a portion of the original audio content may include the utterance of a particular word or phrase, for which a similar utterance of another word or phrase having a similar meaning may be generated as the alternative content. In some embodiments, alternative audio content representing the utterance of a particular word or phrase may be generated to sound as if it was uttered by the same voice as the original audio content. To generate alternative content with the same voice profile as the original audio content, one or more machine learning models may be trained on the original portion and/or additional audio content including the voice from the original audio content. Once trained for a voice profile, a word or phrase may be provided as input to the machine learning models to generate alternative audio content including an utterance of the word or phrase with a same or similar voice profile.

Content generation engine 215 may use one or more machine learning models to generate alternative content based on values of profile attributes and the definitions or meanings of the original content. For example, given the definition or meaning of a particular word or phrase in the original media content and a target language proficiency, the one or more machine learning models may identify alternative words or phrases with a similar meaning that could be understood by someone with a same or higher level of proficiency. As another example, given the definition or meaning of an explicit word or phrase in the original media content and a target content rating, the one or more machine learning models may identify alternative words or phrases with a similar meaning that adhere to the target content rating.

In some embodiments, content generation engine 215 generates alternative content that matches, or is compatible with, one or more profile attribute values of a particular user or group of users. For example, given an age range, or a particular content rating, alternative content may be generated with the same content rating and/or that is appropriate for the provided age range. As another example, given a particular language and/or regional variation of a language, alternative content for a word or phrase in a different language may be translated produce a word or phrase in the particular language, and/or variation of the language, that has a same or similar meaning. In yet another example, given an initial level of language proficiency, alternative content for a word or phrase that requires a higher level of proficiency may include a different word or phrase that would be comprehensible to a person with the initial level of proficiency. To further illustrate, the phrases “second-year” and “petrol station” may be generated as alternative content for “sophomore” and “gas station” to accommodate English speakers who are more familiar with British English as opposed to American English. While described as separate examples above, it should be clear that alternative content may be generated that conforms to multiple profile attribute values at the same time. For example, alternative content may be generated that is appropriate for a different age range and in a different regional language variation than the original portion of media content.

In some embodiments, content generation engine 215 generates alternative content for a single combination of profile attribute values. For example, given a word or phrase in a portion of the original media content, content generation engine 215 may generate a single word or phrase that conforms to or satisfies a combination of attribute values from a profile of a single user or group of users. In this way, content generation engine 215 may avoid unnecessary processing by limiting alternative content generation to the unique combination of attribute values for a profile of a user, or group of users, associated with content delivery device 202. In addition, when executed on content provider server system 220, this may allow for reduced data transmission bandwidth by limiting the alternative content transmitted to content delivery device 202 to only that which conforms to the attribute values for the profile of a user, or group of users, associated with content delivery device 202.

In some embodiments, content generation engine 215 generates alternative content for all, or a subset, of the unique combinations of profile attribute values. For example, given a word or phrase in a portion of the original media content, content generation engine 215 may generate a first word or phrase that conforms to or satisfies a first unique combination of attribute values and a second word or phrase that conforms to or satisfies a second unique combination of attribute values. Subsequently, the first word or phrase and the second word or phrase may be provided to content modification engine 216 to determine which will conform to the particular combination of attribute values for a profile of a user, or group of users. Generating alternative content for all, or a subset, of the unique combinations of profile attribute values may allow content generation engine 215 executing on content provider server system 220 to support broadcast media content distribution while minimizing processing requirements of individual content delivery devices, as described further below.

Content modification engine 216 may include one or more software components that modify portions of original media content with alternative content generated by content generation engine 215 to produce modified, or individualized, media content. As described herein, modifying media content with alternative content may include replacing portions of the original media content with the alternative content. For example, in the case of audio content, modifying a portion of the original audio content may include replacing the digital audio for the portion of the original audio content with the digital audio of the alternative content. Additionally, or alternatively, modifying media content with alternative content may include inserting the alternative content into the original media content and/or combining the two together. For example, in the case of visual content, modifying an image of the original visual content may include superimposing the alternative content over the original content to produce a modified image.

In some embodiments, content modification engine 216 determines which portions of original media content need to be modified to individualize the original media content to a user or group of users. Determining that a portion of original media content needs to be individualized to a user or group of users may include comparing the one or more classifications of the portion (e.g., from content classification engine 214) with the attribute values for the profile of the user, or group of users, to determine whether the classifications conform to or satisfy the attribute values.

One or more rules may be defined to determine whether a classification conforms to or satisfies an attribute value. For example, rules may be defined such that when a comparison between a classification for a portion of media content and an attribute value from a profile of a user, or group of users, indicates that the classification and attribute value are not a match, the classification for the portion does not conform to or satisfy the attribute value. This may be the case for attributes such as a preferred language attribute where any difference between the language of the original media content and the languages understood by a user could make the original media content incompatible to the user. Additionally, or alternatively, rules may be defined such that a classification acts as a minimum or maximum threshold for an attribute value, or vice versa. This may be the case for attributes such as age, preferred content rating, language proficiency, or the like where the values exist on a scale. For example, any content rating classification may be compatible with an attribute value for a user indicating that the user is an adult.

Media output interface 217 may include one or more hardware and/or software components configured to provide the modified content from content modification engine 216 to a user for consumption. For example, media output interface 217 may include one or more hardware interfaces that enables the modified media content to be produced by an external display, such as television 116, and/or a speaker. As another example, media output interface 217 may include one or more interfaces that enables media output interface 217 to transmit the modified media content to another process or device for conversion into a different format for display and/or reproduction.

Content provider server system 220 may include one or more computer systems configured to provide media content to content delivery devices, such as content delivery device 202. Additionally, or alternatively, content provider server system 220 may be configured to partially or fully individualize media content prior to distribution to content delivery devices. For example, content provider server system 220 may include the same or similar software and/or hardware components as content delivery device 202, such as profile engine 212, content classification engine 214, content generation engine 215, and content modification engine 216.

As illustrated, content provider server system 220 may further include profiles database 228. Profiles database 228 may store and manage profiles of individual users and/or groups of users. For example, profile engine 212 executing on content delivery device 202 may provide the profile of a user, or group of users, associated with content delivery device 202 to profile engine 212 executing on content provider server system 220 for storage in profiles database 228 with the profiles of other users and/or groups of users. Additionally, or alternatively, profile engine 212 executing on content delivery device 202 may provide one or more inputs, such as user settings, control inputs, or the like, to profile engine 212 executing on content provider server system 220. Profile engine 212 executing on content provider server system 220 may then generate the profile and store it in profiles database 228. In some embodiments, profile engine 212 executing on content provider server system 220 generates profiles for various demographics and/or geographic region.

As described above, content provider server system 220 may individualize media content to an identifiable user, as in the case of unicast media content distribution, such as IPTV. For example, in response to a request for media content from a particular user, device associated with a user, or user account, a profile of the user may be used to individualize the media content to the particular user. In this way, media content provided to one user may be different than media content provided to another user based on the individual profiles of each user.

In some embodiments, content provider server system 220 individualizes media content to a broader audience, as in the case of broadcast media content distribution, based on the common and/or predominant attribute values of users in the audience. For example, given a broadcast audience in Mexico, content provider server system 220 may provide individualized media content in Latin American Spanish. Additionally, or alternatively, media content individualization may be distributed between content provider server system 220 and each individual content delivery device, such as content delivery device 202. For example, and as described above, content provider server system 220 may classify the portions of the original media content and generate alternative content for each unique combination of attribute values. Content provider server system 220 may then broadcast the original media content, the classifications for each portion, and the alternative content for each unique combination of attribute values to the network of content delivery devices. Once received, each individual content delivery device may determine whether and how to individualize the original media content for the user, or group of users, based on the profile attribute values of the individual user, or group of users, associated with the content delivery device, as described above in relation to content modification engine 216.

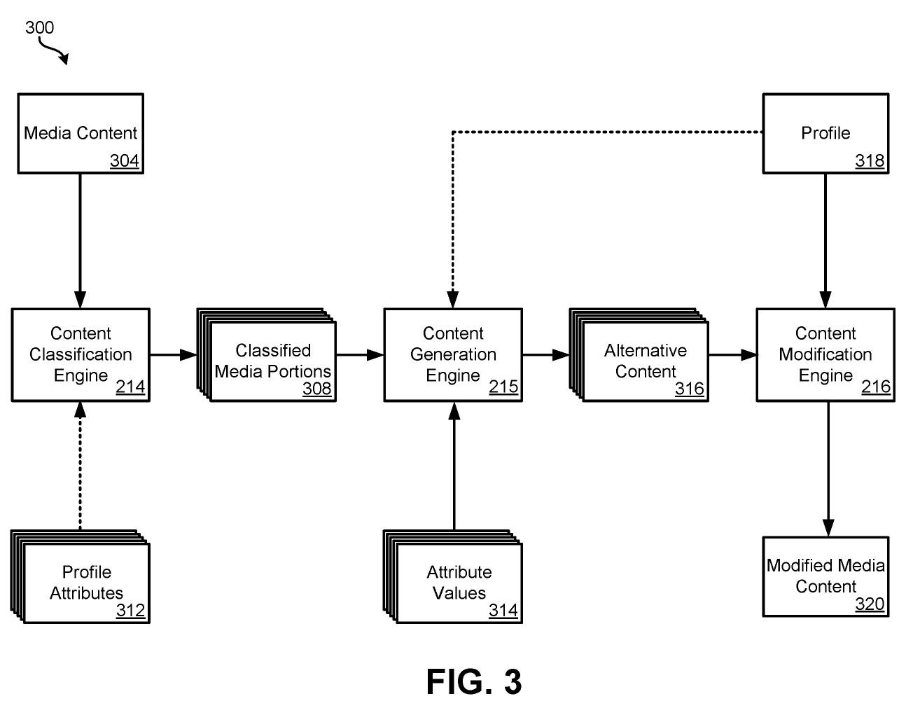

FIG. 3 illustrates an exemplary data flow 300 for individualizing media content according to embodiments described herein. As illustrated, the process of individualizing media content may be performed by one or more components of system 200 described above, such as content classification engine 214, content generation engine 215, and content modification engine 216. As further illustrated, the process may begin with the generation of classified media portions 308 by content classification engine 214 from original media content 304.

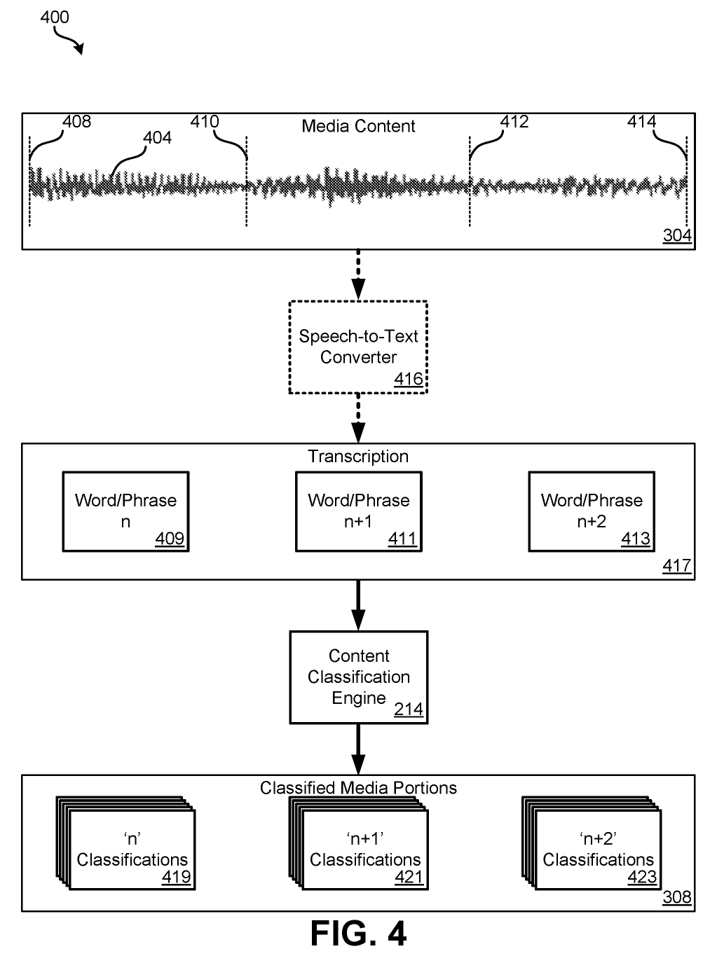

FIG. 4 illustrates an exemplary data flow 400 for classifying original media content 304. As illustrated, original media content 304 may include audio content 404, such as the audio track for a movie or show. As described above, one or more portions of audio content 404 may correspond to spoken words and/or phrases. For example, a first portion of audio content 404 between first time 408 and second time 410 may correspond to a first word/phrase 409, a second portion of audio content 404 between second time 410 and third time 412 may correspond to a second word/phrase 411, and a third portion of audio content 404 between third time 412 and fourth time 414 may correspond to a third word/phrase 413.

Each portion of audio content 404 corresponding to a word or phrase may be identified from transcription 417 of audio content 404. Optionally, transcription 417 of audio content 404 may be generated directly from audio content 404 using one or more natural language processors (NLPs), such as speech-to-text converter 416. Additionally, or alternatively, original media content 304 may include transcription 417 and/or transcription 417 may be obtained from a same sources as original media content 304, as in the case of subtitles or closed captioning. In some embodiments, each word or phrase in transcription 417 is associated with a pair of timestamps or a time window that corresponds to the point in time in audio content 404 when the word or phrase is uttered.

As described above, content classification engine 214 may generate one or more classifications for all or a subset of words and phrase in transcription 417. For example, and as illustrated, content classification engine 214 may generate a first set of classifications 419 for first word/phrase 409, a second set of classifications 421 for second word/phrase 411, and a third set of classifications 423 for third word/phrase 413. Collectively, the classifications for each word or phrase may constitute a classified media portion of classified media portions 308.

Returning to FIG. 3, content classification engine 214 may be trained to generate classifications corresponding to each of one or more profile attributes 312. As described above, profile attributes 312 may be defined for various characteristics inherent or ascribed to persons, such as a person’s age, native language, a dialect of the native language, learned languages/dialects, language proficiency, preferences, or the like. As such, classifications for portions of media content may be defined or learned for corresponding characteristics inherent to a portion of media content, such as the age appropriateness of the content, a language and/or dialect represented by the content, or the like.

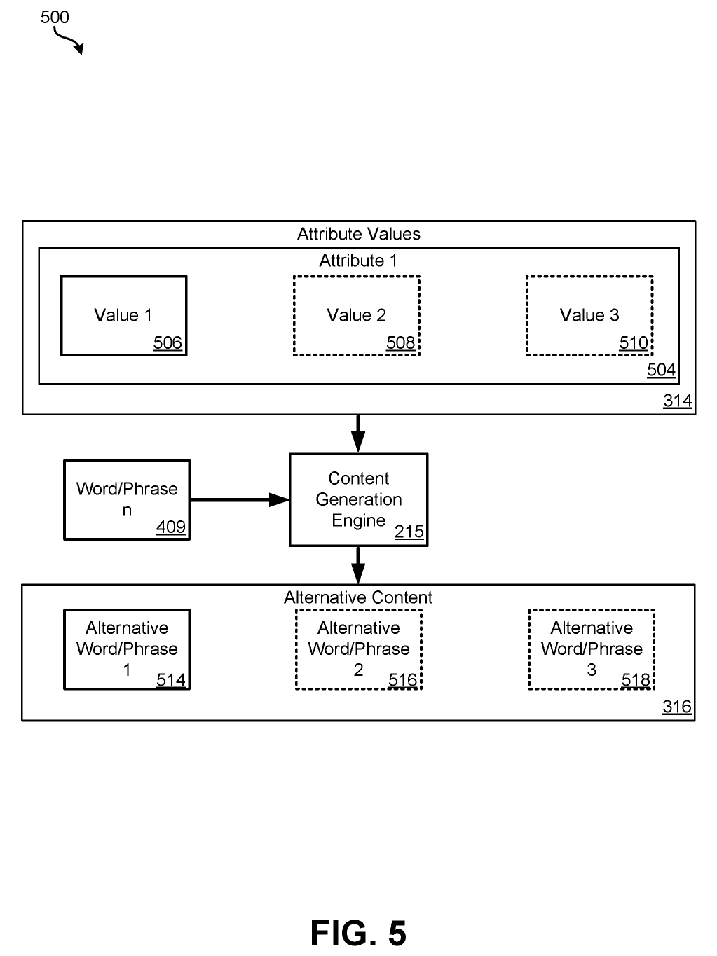

As further illustrated, flow 300 may proceed with the generation of alternative content 316 by content generation engine 215 for classified media portions 308 using one or more attribute values 314. FIG. 5 illustrates an exemplary data flow 500 for generating alternative content. In the context of flow 300, flow 500 may begin where flow 400 ended by generating alternative content 512 for each portion of audio content 404 corresponding to a word or phrase, such as first word/phrase 409. As further illustrated, content generation engine 215 may take, as input, one or more values, such as first value 506, second value 508, and third value 510, for one or more profile attributes, such as first attribute 504. As further illustrated, content generation engine 215 may generate, as an output, alternative content 316 for each portion of original media content 304, such as the portion of audio content 404 corresponding to first word/phrase 409.

As described above, alternative content 316 for a portion of original media content 304 may be generated for a single attribute value. For example, and as illustrated, alternative content 316 for first word/phrase 409 may include first alternative word/phrase 514 generated for first value 506 of first attribute 504. While not illustrated, first alternative word/phrase 514 may be further based on a value for one or more additional attributes. For example, and as illustrated in FIG. 3, alternative content 316, including first alternative word/phrase 514, may be based on a unique combination of attribute values 314 from profile 318 of a user requesting to consume an individualized version of original media content 304.

Additionally, or alternatively, alternative content 316 for a portion of original media content 304 may be generated for multiple values of a single attribute and/or multiple unique combinations of values from two or more attributes. For example, and as further illustrated, alternative content 316 for first word/phrase 409 may optionally include second alternative word/phrase 516 generated for second value 508 and third alternative word/phrase 518 generated for third value 510. As explained above, the ability to generate alternative content specifically for the attribute values of a user and also to generate multiple variations of alternative content for multiple unique combinations of attribute values can have different applications and associated benefits.

For example, in the context of broadcast media distribution, generating alternative content specifically for the attribute values of a user can allow the media content provider to minimize their overall data transmission needs when the processing capabilities of content delivery devices are able to support the generation of alternative content without causing an excessive delay in the ultimate delivery of the individualized media content. However, to reduce the processing needs of content delivery devices while still being able to individualize broadcast media content, multiple variations of alternative content for multiple unique combinations of attribute values may be generated by the broadcast media source, such as content provider server system 220, and provided to content delivery devices, such as content delivery device 202. Subsequently, and based on profiles of users associated with each individual content delivery device, the content delivery devices may select the appropriate variation of the pre-generated alternative content to use when modifying the original media content. In the context of unicast media distribution, such as internet-based streaming services, generating alternative content specifically for the attribute values of a user may be performed by the provider and/or the content delivery device, depending on the processing capabilities of the provider and content delivery device.

Returning to FIG. 3, flow 300 may conclude with the generation of modified media content 320 by content modification engine 216 from alternative content 316 and profile 318. For example, and as described above, content modification engine 216 may replace original portions of original media content 304, such as a portion of audio containing a first word or phrase, with corresponding alternative content, such as an audio clip containing an alternative word or phrase. As another example, content modification engine 216 may overlay alternative content on top of a portion of original media content 304.

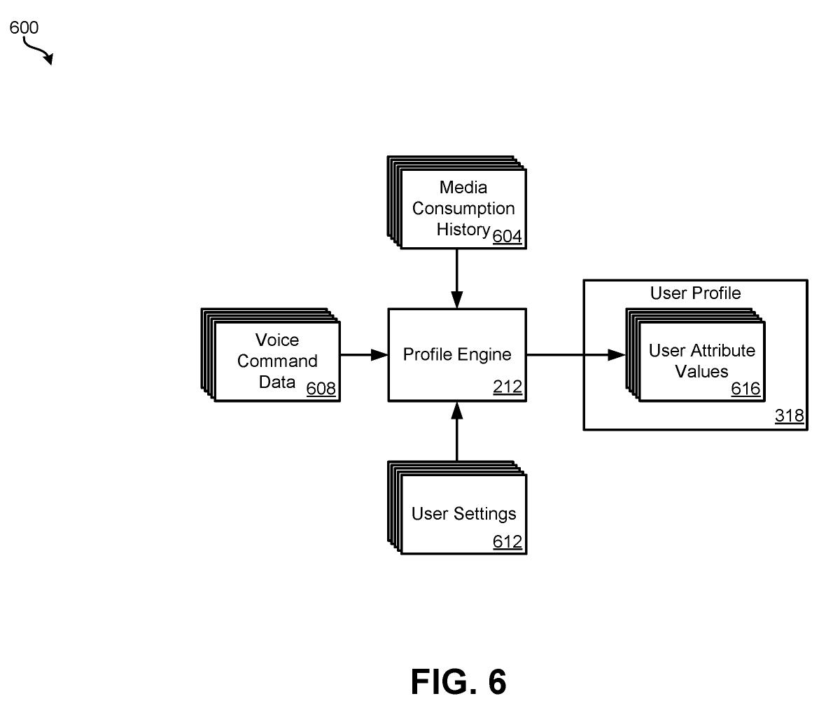

FIG. 6 illustrates an exemplary data flow 600 for generating a profile of a user according to embodiments described herein. As illustrated, generating and/or updating profiles, such as profile 318, may be performed by one or more components of system 200 described above, such as profile engine 212. As described above, profile 318 may include a unique combination of user attribute values 616. Each value of user attribute values 616 may identify a particular characteristic about a person, or group of people. For example, in the case of the profile of a single user, user attribute values 616 may identify the user’s age, native spoken language, a regional dialect spoken by the user, other languages spoken by the user, language proficiency ratings for each language, or the like. As another example, and in the case of the profile of a group of users, user attribute values 616 may identify an average age of the group, a minimum age in the group, languages spoken by all, or most, members of the group, an average language proficiency of the group, a minimum language proficiency of the group, dialects spoken or preferred by all, or most, members of the group, or the like.

As described above, profile engine 212 may generate, populate, and/or update profile 318 based on implicit information obtained from or about a user, such as media consumption history 604. Media consumption history 604 may include records of historical media content consumed by a user. Each record may include a title of the media content as well as one or more characteristics about the media content, such as a content rating, a genre, one or more languages represented in the media content, regional dialects for the one or more languages, language proficiency ratings/scores for the content of the one or more languages, or the like. In some embodiments, the one or more characteristics about the media content may be identified by a content classification engine, such as content classification engine 214 described above. Each record may further include information about the playback session of the media content, such as whether subtitles and/or closed-captioning were used, and if so, what language was used.

Based on media consumption history 604 for a user, profile engine 212 may derive one or more of user attribute values 616 for profile 318 of the user. For example, profile engine 212 may determine that the user speaks and/or understands one or more languages based on the one or more languages being represented in past media content consumed by the user. As another example, profile engine 212 may determine that a user does not speak and/or fully understand a particular language based on historical use of subtitles by the user when consuming videos that include the particular language. In yet another example, profile engine 212 may determine an approximate age of the user and/or a preferred content rating for the user, based on the average and/or predominant content ratings of the media content historically consumed by the user.

Profile engine 212 may further generate, populate, and/or update profile 318 based on voice command data 608. Voice command data 608 may include actual audio recordings of the user’s voice when providing voice commands to a voice control enabled device, such as a voice enabled remote control, a mobile phone, or the like. Additionally, or alternatively, voice command data 608 may include transcriptions of such audio recordings. As described above, one or more natural language processors may be executed on the actual recordings and/or transcripts to identify one or more characteristics about a user, such as an approximate age of the user, languages spoken by the user, proficiencies in the languages spoken by the user, regional dialects spoken by the user, or the like. Once identified, profile engine 212 may populate and/or update one or more of user attribute values 616 based on the derived information.

As further described above, profile engine 212 may generate, populate, and/or update profile 318 based on explicit information provided by a user, or group of users. For example, and as illustrated, profile 318 may be further based on user settings 612. User settings 612 may be provided by a user via one or more user interfaces at varying points in time. For example, one or more settings, preferences, and/or user identifying information, may be provided by users during account creation (e.g., when signing up for a satellite and/or Internet streaming service) and/or during an initial device configuration (e.g., when setting up a content delivery device for the first time). Additionally, or alternatively, users may modify existing settings, identifying information, or the like, on demand via one or more user interfaces.

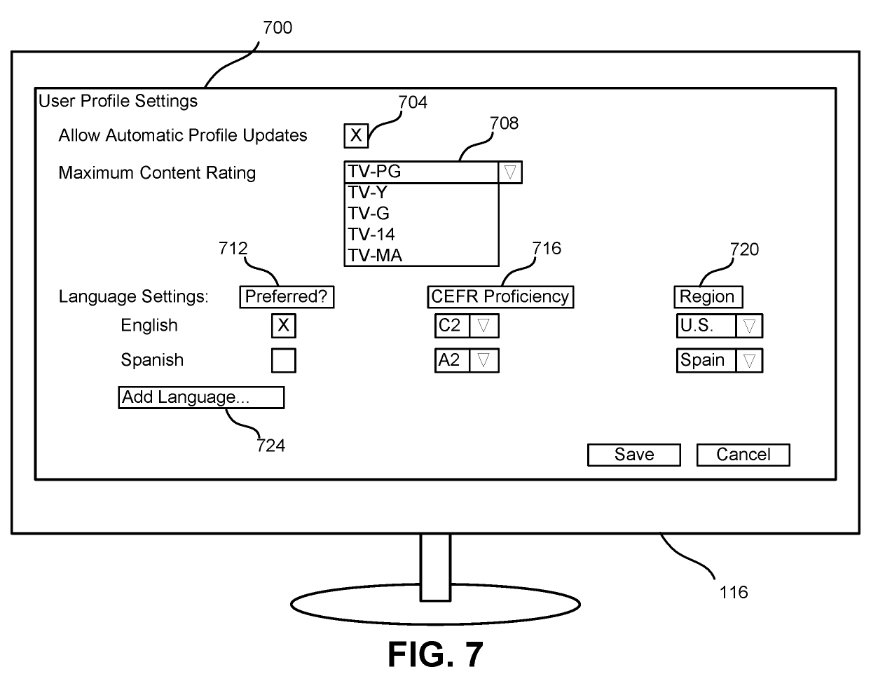

FIG. 7 illustrates an exemplary user interface 700 for providing information for a profile of a user according to embodiments described herein. As illustrated, user interface 700 may be presented via television 116. In some embodiments, user interface 700 is provided by a component executing on television 116, and/or a content delivery device connected to television 116, such as profile engine 212. Additionally, or alternatively, user interface 700 may be accessible over the Internet from a web-service provider, such as content provider server system 220. For example, user interface 700 may be accessed via a web-based application or browser executing on television 116, a connected content delivery device, and/or another computing device, such as mobile phone 140, a laptop or tablet computer, or the like.

As illustrated, user interface 700 may include one or more interface elements that allow a user to set various settings related to their profile. For example, user interface 700 includes automatic profile update setting 704. Automatic profile update settings 704 may enable and disable a content delivery device and/or content provider server system from automatically obtaining, analyzing, and/or utilizing implicit information from a user, as described above, to set and/or update attribute values for the user. Automatic profile update settings 704 may be disabled by default to protect the privacy of users.

User interface 700 may further include interface elements related to content rating settings, such as maximum content rating element 708. As illustrated, maximum content rating element 708 may include a drop-down menu element that allows a user to define a maximum content rating for media consumption by a user, or group of users, associated with a content delivery device. While not illustrated, user interface 700 may include additional elements related to content ratings, such as a field to enter a user’s age, maximum content ratings for different types of media content (e.g., movies versus shows versus music), allowable and/or restricted content categories (e.g., violence, drug use, gambling), or the like.

As further illustrated, user interface 700 may include interface elements related to languages spoken and/or understood by a user, or group of users. For example, user interface 700 may include preferred language setting 712, language proficiency setting 716, and regional dialect setting 720. Each setting may have a unique entry for each of one or more languages spoken and/or understood by the user. For example, and as illustrated, user interface 700 includes entries for the English and Spanish languages. Preferred language setting 712 may be used to identify a language in which a user prefers their content to be. For example, and as illustrated, English has been identified as the preferred language in user interface 700. Language proficiency setting 716 may be used to identify the proficiency of the user in each language. For example, user interface 700 indicates that the user has a CEFR proficiency of “C2” for English, and “A2” for Spanish. Regional dialect setting 720 may further identify the regional dialect of each language that the user prefers or understands best. For example, user interface indicates that the user prefers American English over other dialects of the English language, and Peninsular Spanish over other dialects of the Spanish language. As further illustrated, user interface 700 may include new language option 724, which may be used to add additional languages spoken and/or understood by the user.

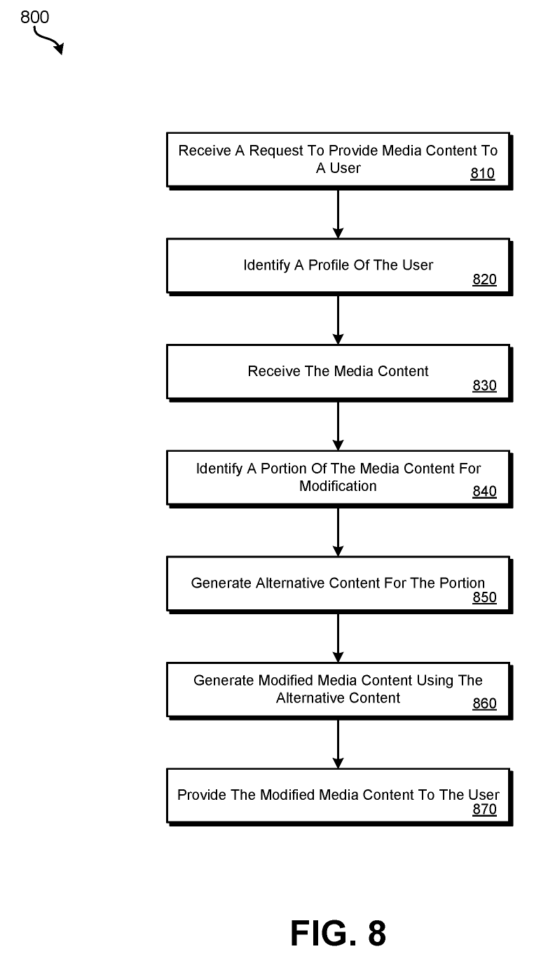

Various methods may be performed using the systems and devices detailed in relation to FIGS. 1-7. FIG. 8 illustrates an embodiment of a method 800 for individualizing media content. In some embodiments, one or more blocks of method 800 may be performed by components of system 100 and system 200, such as content delivery device 202 and/or content provider server system 220. For example, the components executing on content delivery device 202 described above may perform some or all of the steps of method 800. Additionally, or alternatively, some of the steps of method 800 may be performed by components executing on content provider server system 220.

Method 800 may include, at block 810, receiving a request to provide media content to a user. The request may be received via a control input interface of a content delivery device. In some embodiments, the request is transmitted from the content delivery device to a content provider server system, such as an Internet based streaming service provider for additional processing to identify the requested media content and provide it to the content delivery device. Additionally, or alternatively, the control input interface may process the request and take one or more additional steps to begin receiving the requested media content from a broadcasting source, such as a satellite or cable television network provider. The requested media content may include audio (e.g., music), visual (e.g., pictures), and/or audiovisual (e.g., videos) in nature. For example, the request may be to view a particular movie or television show. As another example, the request may be to view video content associated with a particular broadcast television channel.

At block 820, a profile of the user is identified. As described above, the profile of the user may include individual values for predefined attributes, such as an age of the user, languages spoken by the user, language proficiencies for the spoken languages, regional dialects of the languages, or the like. As described further herein, the values of the profile may be provided by the user and/or derived from information obtained from or about the user. In some embodiments, the profile of the user is identified from a datastore using information about the user. For example, based on a user identifier included in the request for the media content, and/or a device identifier associated with the device that received the request, a unique profile for the user may be identified.

At block 830, the media content is received. The media content may be received by a content delivery device from a content provider server system. Additionally, or alternatively, the media content may be received by a content provider server system from a content source before providing the media content, and/or modified media content, to the content delivery device for presentation to the user. As described above, the media content may represent original media content in the form of audio and/or video data.

At block 840, a portion of the media content is identified for modification. The portion of the media content may include a subset of the original audio and/or video data. The portion may include audio and/or video data including a particular word or phrase. For example, the portion may include a clip of audio from an audio track for a movie or television show in which a word or a phrase is spoken. Identifying the portion for modification may include identifying and classifying each portion of the media content. For example, one or more techniques may be used to identify discrete words or phrases from audio content, such as speech recognition, natural language processing, and audio signal processing. Additionally, or alternatively, discrete words or phrases from a transcript of the audio content may be used to identify corresponding portions of the audio content including the discrete words or phrases.

Once identified, one or more classifications may be generated for each portion of the media content. Each classification may correspond to a profile attribute. For example, a portion may receive classifications indicating a content rating of the portion, a language included in the portion, a language proficiency required to understand the portion, or the like. In some embodiments, identifying a portion of the media content for modification includes comparing the one or more classifications for the portion with one or more attribute values. Based on the comparisons, a determination may be made that a portion is to be modified. For example, a determination that a portion is to be modified may be made in response to determining that the portion has a content rating classification that is inappropriate for an age of a user (e.g., the portion is rate for a greater age range). As another example, a determination that a portion is to be modified may be made in response to determining that a portion has language classifications that are incompatible and/or do not match with the languages and/or language proficiencies of a user (e.g., a different language not spoken/understood by a user, or that requires a greater language proficiency than that of the user).

At block 850, alternative content is generated for the portion. As described herein, alternative content may include content of the same form as the original media content, but that includes a different substance. For example, alternative content for a portion of original media content may include an alternative word or phrase for the original word or phrase included in the portion of original media content. Alternative content may be generated based on the substance of the portion of original media content and one or more attribute values. For example, alternative content may be generated for a unique combination of attribute values from the profile of the user. In some embodiments, there is a one-to-one correspondence between a portion of original media content and the alternative content. For example, given a portion of original media content including a particular word or phrase, a single piece of alternative content may be generated based on a single combination of attribute values. Additionally, or alternatively, multiple alternatives may be generated for a portion of original media content for each unique combination of attribute values.

As described above, alternative content may be generated for original media content at the content delivery device and/or at the source of the original media content and provided to the content delivery device. For example, upon receiving the media content from a content provider system, a content delivery device may identify and classify the portions of the original media content, identify the portions for modification based on the classifications and the profile of the user, and generate alternative content specifically for the attribute values from the profile of the user. As another example, a content provider server system may identify and classify the portions of the original media content, generate alternative content for each unique combination of attribute values. Subsequently, the alternative content for each unique combination can be provided to the content delivery device for subsequent identification and modification of portions of the original media content to meet the specific attribute values of the user. Additionally, or alternatively, the original media content may be modified to meet the specific attribute values of a user and provided to the content deliver device of the user.

At block 860, modified media content is generated using the alternative content. Generating the modified media content may include replacing portions of the original media content with the alternative content. For example, in the case of audio content, modifying a portion of the original audio content may include replacing the digital audio for the portion of the original audio content with the digital audio of the alternative content. Additionally, or alternatively, modifying media content with alternative content may include inserting the alternative content into the original media content and/or combining the two together. For example, in the case of visual content, modifying an image of the original visual content may include superimposing the alternative content over the original content to produce a modified image.

At block 870, the modified media content is provided to the user. Providing the modified media content to the user may include transmitting the modified media content to the content delivery device generated the request for the media content. For example, in the case of Internet-based streaming services, after receiving the request from a remote content delivery device and generating the modified media content for the profile of a user associated with the content delivery device, the streaming service may begin streaming the modified media content back to the remote content delivery device over the Internet. Additionally, or alternatively, providing the modified media content to the user may include transmitting the modified media content to one or more hardware interfaces (e.g., a speaker and/or a display), and/or one or more processes or devices for conversion into a different format for display and/or reproduction by an output device, such as a television.

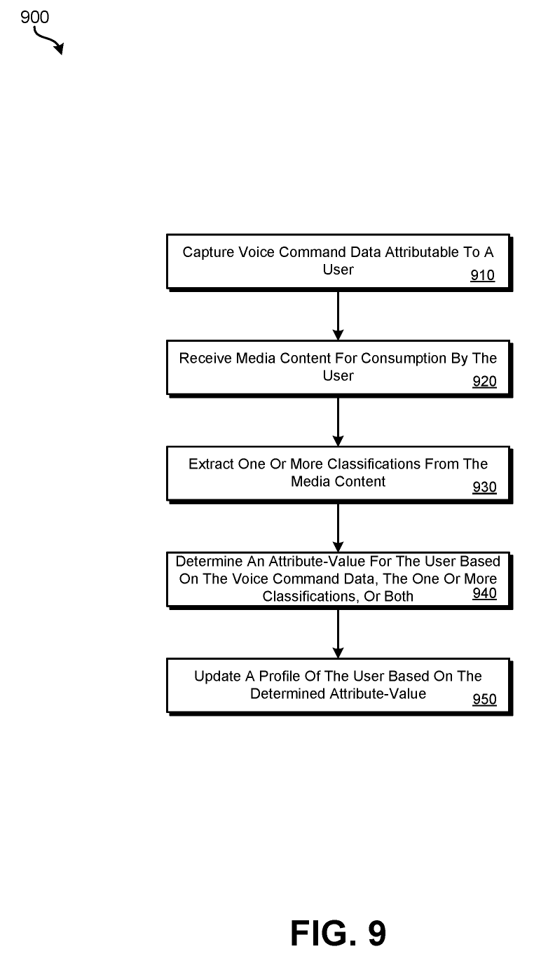

FIG. 9 illustrates an embodiment of a method 900 for generating a profile of a user. In some embodiments, one or more blocks of method 900 may be performed by components of system 100 and/or system 200, such as content delivery device 202 and/or content provider server system 220. For example, the components executing on content delivery device 202 described above may perform some or all of the steps of method 900. Additionally, or alternatively, some of the steps of method 900 may be performed by components executing on content provider server system 220.

Method 900 may include, at block 910, capturing voice command data attributable to a user. As described above, voice command data may include spoken instructions, queries, or prompts issued by a user. The voice command data may be captured by a voice-enabled device, such as a smartphone, smart speaker, smart watch, or other electronic device equipped with one or more microphones, such as a voice-enabled remote. The voice command data may be captured as an audio recording, transcribed text, or executable commands. For example, an audio recording including spoken audio may be transcribed to text using one or more natural language processing algorithms. As another example, one or more command interpretation algorithms and/or processes may be used to analyze and process audio input, and/or transcribed text of the audio input, to identify the intended user command.

At block 920, media content for consumption by the user is received. The media content can be in various forms such as audio, video, text, or images. The substance of the media content can represent information, entertainment, educational material, news, or advertisements. The media content can be received from various sources, including online streaming services, social media platforms, news websites, educational portals, or direct downloads from content providers. The media content can be received via internet connections, broadcasting networks, direct downloads, or streaming services, accessible through devices such as smartphones, computers, smart TVs, tablets, or other similar content delivery devices, as described above.

Block 920 may optionally include receiving information about historical media consumption by the user. Information about historical media consumption can be in the form of digital logs, usage reports, or analytical data. This information may include details such as the types of media consumed (audio, video, text, images), the substance (e.g., titles, genres, etc.) of the media, timestamps of consumption, methods of consumption (e.g., with or without subtitles), duration of engagement, frequency of access, content ratings, interactions with the content, metadata like genres, themes, sources of the consumed media, or the like. In some embodiments, the information about the historical consumption is generated and/or maintained by each content delivery device responsible for providing the consumed media, such as content delivery device 202. Additionally, or alternatively, the historical media consumption may be created and/or maintained by the source of the consumed media content, such as content provider server system 220. In some embodiments, the information about the historical media consumption is generated and/or updated as media content is received for consumption by the user, as described above.

At block 930, one or more classifications are extracted from the media content. As described above, each classification may correspond to an attribute defined for characteristics or qualities attributable to a user. For example, the one or more classifications may be extracted for a genre of the media content, subject matter of the media content, a format of the media content, languages included in the media content, a complexity of the language included in the media content, an intended audience age for the media content, or the like. The one or more classifications may be extracted from the media content using techniques such as content analysis, metadata extraction, machine learning algorithms, natural language processing, and image or audio recognition, which analyze the media's features and context to determine the appropriate classifications. As described above, the one or more classifications for the media content may be stored in association with historical media consumption by the user. For example, as a user consumes media content, the historical media consumption may analyzed to identify trends, patterns, and/or statistics, such as a language in media content commonly consumed by the user, an average or maximum content rating consumed by the user, or the like.

At block 940, an attribute-value is determined for the user based on the voice command data, the one or more classifications from the media content, or both. As described above, an attribute-value for a user may be a specific piece of information that quantifies or qualifies an attribute or characteristic of a user, such as a user’s age, their native language, their language proficiency in various languages, or the like. In some embodiments, such attribute-values are determined or derived from voice command data. For example, using recorded audio of a user’s speech, and/or a transcription of the recorded audio, a language spoken by the user, a language proficiency of the user, and/or an approximate age of the user may be determined by analyzing the linguistic features, vocabulary usage, and grammatical structures present in the user's speech or text.

Additionally, or alternatively, the one or more classifications extracted for the media content consumed by the user may be used to determine or derive various attribute-values. For example, given the language most commonly represented in the historical media consumption, and/or the average complexity of the language, a language preferred by the user, and/or the user’s proficiency in the language can be inferred. This analysis can identify patterns in the user's media consumption to determine their preferred language and estimate their proficiency based on the complexity and nature of the content they frequently engage with. As another example, given the average and/or predominant content rating of the historically consumed media, an approximate age of the user may be inferred.

At block 950, a profile of the user is updated based on the determined attribute-value. The profile of the user can be updated by incorporating the newly determined attribute-value into the user’s existing profile data. This update can include adding new attributes, modifying existing values, or enhancing the profile with more detailed information based on the latest analysis. The profile can be maintained in various locations, such as a centralized profile database in a content provider server system, or in a local storage of a content delivery device.

While described in the context of a profile of a single user, method 900 may similarly be used to generate and/or update a profile of a group of users. For example, in the context of personal media consumption, a profile may be generated and/or maintained that includes attribute-values common to each user who may use a content delivery device, or group/family account, to consume media content. As another example, a profile may be generated and/or maintained for broader groups of people within a geographic region. In this example, the attribute values may indicate one or more languages spoken or understood by the people in the region, a regional dialect predominantly used by the people in the region, or the like.

Profiles may be used to individualize media content for a user, or group of users. For example, and as described above in relation to method 800, the attribute-values in a profile of a user may be used to identify portions of original media content that may be inappropriate for a user, either in terms of content ratings or understandability. Furthermore, the attribute-values in a profile of a user may be used to generate alternative content for the identified portions that are inappropriate for a user. Additionally, or alternatively, the attribute-values in a profile of a user may be used to select alternative content from a collection generated for different attribute-value combinations that will be best suited to the user.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of providing individualized content to a user, comprising:
receiving, by an application executing on a user device, a user request to provide audiovisual content to a user via the user device;
identifying, by the application, a linguistic profile of the user, wherein the linguistic profile comprises user values for each of one or more predefined language attributes, wherein the user values comprise a user language proficiency value indicating the user’s proficiency level in a language, a user dialect value indicating a preferred dialect of the language, or both;
receiving, by the application, the audiovisual content from a content provider server system via one or more communications networks, wherein the audiovisual content comprises audio of a plurality of words or phrases spoken in the language;
identifying, by the application, one or more content values for a first word or phrase in a portion of the audio, wherein each of the one or more content values corresponds to a predefined language attribute of the one or more predefined language attributes, and the one or more content values comprise a content language proficiency value indicating a minimum proficiency level needed to understand the first word or phrase, a content dialect value indicating that the first word or phrase is specific to a first dialect, or both;
determining, by the application, that the minimum proficiency level indicated by the content language proficiency value is greater than the user’s proficiency level indicated by the user language proficiency value, the first dialect indicated by the content dialect value is not the same as the preferred dialect indicated by the user dialect value, or both;
identifying, by the application, an alternative word or phrase for the first word or phrase based on a meaning of the first word or phrase, as well as the user language proficiency value, the user dialect value, or both;
generating, by the application, replacement audio including the alternative word or phrase;
replacing, by the application, the portion of the audio with the replacement audio in the audiovisual content to produce modified audiovisual content; and
presenting, by the application, the modified audiovisual content to the user via the user device in response to the user request.

2. A method of providing individualized content to a user, comprising:
receiving, by an application executing on a user device, a user request to provide media content to a user via the user device;
identifying a profile of the user, wherein the profile comprises user values for each of one or more predefined attributes;
receiving the media content from a content provider server system via one or more communications networks, wherein the media content comprises a plurality of portions and each portion of the plurality of portions is associated with a first content value for a predefined attribute of the one or more predefined attributes;
identifying a portion of the media content for modification based on a user value for the predefined attribute and the first content value of the portion;
generating alternative content for the portion based on the user value;
generating modified media content using the alternative content, wherein generating the modified media content includes replacing the portion of the media content with the alternative content or adding the alternative content to the portion of the media content; and
providing the modified media content to the user via the application executing on the user device.

3. The method of claim 2, wherein identifying the portion of the media content for modification comprises determining that the first content value and the user value are different.

4. The method of claim 2, further comprising:
executing an artificial intelligence (AI) model on the portion of the media content, wherein the AI model is trained to generate content values for portions of media content; and
receiving, from the AI model, the first content value for the predefined attribute.

5. The method of claim 2, wherein the media content comprises vocal audio content, and the method further comprises:
obtaining a transcription of the vocal audio content;
identifying a word or phrase of interest in the transcription of the vocal audio content; and
identifying a sample of the vocal audio content that contains the word or phrase of interest as the portion of the media content.

6. The method of claim 5, wherein:
the media content further comprises closed captions, subtitles, or both; and
the transcription of the vocal audio content is obtained from the closed captions, the subtitles, or both.

7. The method of claim 5, wherein obtaining the transcription comprises inputting the vocal audio content to a speech-to-text conversion machine learning model.

8. The method of claim 5, wherein generating the alternative content comprises:
identifying a replacement word or phrase for the word or phrase of interest based on a definition of the word or phrase of interest and the user value; and
generating a new audio sample containing the replacement word or phrase, wherein the modified media content is generated by replacing the sample of the vocal audio content with the new audio sample.

9. The method of claim 8, wherein generating the new audio sample containing the replacement word or phrase comprises:
inputting the replacement word or phrase and information about a voice that vocalized the word or phrase in the vocal audio content to a generative text-to-speech AI model; and
receiving the new audio sample from the generative text to speech AI model.

10. The method of claim 2, wherein:
the media content comprises text;
generating the alternative content comprises identifying a replacement word for a word of interest included in the text based on a definition of the word of interest and the user value; and
generating the modified media content comprises replacing the word of interest in the text with the replacement word.

11. The method of claim 2, wherein:
the media content comprises visual content;
an image in the visual content is identified as the portion;
generating the alternative content comprises modifying the image based on the user value; and
generating the modified media content comprises replacing the image in the visual content with the modified image.

12. The method of claim 2, wherein:
the predefined attribute is an age attribute;
the content value for the portion indicates an appropriate age for consumption of the portion;
the user value indicates an age of the user;
identifying the portion for modification comprises determining that the appropriate age for consumption exceeds the age of the user; and
generating the alternative content comprises identifying replacement content for the portion that is appropriate for users having the age of the user.

13. The method of claim 2, wherein:
the predefined attribute is a language proficiency attribute for a language;
the user value indicates a proficiency with which the user comprehends words or phrases in the language;
the content value indicates a minimum proficiency needed to comprehend a word or phrase in the language contained in the portion;
identifying the portion for modification comprises determining that the user value is less than the content value for the portion, indicating that a higher language proficiency is needed to comprehend the word or phrase contained in the portion of the media content; and
generating the alternative content comprises identifying a replacement word or phrase that is comprehensible to users having a language proficiency indicated by the user value.

14. The method of claim 2, wherein:
the predefined attribute is a regional language attribute for a language;
the user value indicates a first dialect of the language that is understood by the user;
the content value indicates whether a word or phrase contained in the portion is common to all dialects of the language or is derived from a particular dialect of the language;
identifying the portion for modification comprises determining, based on the content value and the user value, that the word or phrase contained in the portion is specific to a second dialect of the language that is different from the first dialect, indicating that a different word or phrase is used for the word or phrase in the portion of the media content by users having the user value; and
generating the alternative content comprises identifying the different word or phrase for the user value.

15. The method of claim 2, further comprising:
creating, by the application executing on the user device, an audio recording of speech attributable to the user;
providing, by the application executing on the user device, the audio recording to a spoken language analysis machine learning model to identify the user values for at least one of an age attribute that indicates appropriate content ratings for the user, a language attribute that indicates a language spoken by the user, a dialect attribute that indicates a dialect of the language spoken by the user, or a language proficiency attribute that indicates how well the user comprehends the language;
receiving, from the spoken language analysis machine learning model, the user values for the one or more language attributes; and
updating the profile of the user to include the user values for the one or more language attributes.

16. The method of claim 2, further comprising:
receiving a history of media content consumption by the user, wherein the history of media content consumption identifies past media content consumed by the user;
analyzing the history of media content consumption to identify at least one of an average content rating for the past media content, a language of speech represented in the past media content, a dialect of the language represented in the past media content, or a minimum language proficiency needed to comprehend the speech in the past media content; and
updating the user values in the profile of the user for at least one of an age attribute based on the average content rating, a language attribute based on the language of the speech, a dialect attribute based on the dialect of the language, or a language proficiency attribute based on the minimum language proficiency.

17. The method of claim 16, wherein:
the history of media content consumption further identifies the past media content that was consumed by the user with closed captioning enabled; and
analyzing the history of media content consumption to identify the user values comprises adjusting a language proficiency value for the language proficiency attribute associated with the language, the dialect, or both, of speech in the past media content that was consumed by the user with closed captioning enabled.

18. An individualized media content delivery system, comprising:
one or more processors; and
a computer-readable storage media storing computer-executable instructions that, when executed by the one or more processors, cause the individualized media content delivery system to:
receive a user request to provide media content to a user via a user device;
identify a profile for the user, wherein the profile comprises user values for each of one or more predefined attributes;
receive the media content, wherein the media content comprises a plurality of portions and each portion of the plurality of portions is associated with a first content value for a predefined attribute of the one or more predefined attributes;
identify a portion of the media content for modification based on a user value for the predefined attribute and the first content value of the portion;
generate alternative content for the portion based on the user value;
generate modified media content using the alternative content, wherein generating the modified media content includes replacing the portion of the media content with the alternative content or adding the alternative content to the portion of the media content; and
provide the modified media content to the user via the application executing on the user device.

19. The individualized media content delivery system of claim 18, further comprising:
a plurality of content delivery devices comprising the user device; and
a content provider server system;
wherein the computer-executable instructions cause the content provider server system to:
identify the first content value for the portion of the media content from the media content;
generate a collection of alternative content for the portion based on possible user values for the predefined attribute, wherein the collection of alternative content comprises the alternative content; and
transmit the media content, the first content value, and the collection of alternative content for the portion to the plurality of content delivery devices; and
wherein the computer-executable instructions cause the user device to:
identify the portion by comparing the user value with the first content value received from the content provider server system;
select the alternative content from the collection of alternative content based on the user value and a content value associated with the alternative content; and
replace the portion of the media content with the alternative content or add the alternative content to the portion of the media content.

20. The individualized media content delivery system of claim 18, wherein the media content comprises vocal audio content, and the computer-executable instructions further cause the individualized media content delivery system to:
obtain a transcription of the vocal audio content;
identify a word or phrase of interest in the transcription of the vocal audio content; and
identify a sample of the vocal audio content that contains the word or phrase of interest as the portion of the media content.
